(19) United States
(12) Patent Application Publication
(10) Pub. No.: US 2021/0243401 A1
(43) Pub. Date: Aug. 5, 2021

(54) PROVIDING A MULTIVIEW EXPERIENCE

(71) Applicant: Sony Corporation, Tokyo (JP)

(72) Inventors: Steven Richman, San Diego, CA (US); Jason Clement, San Diego, CA (US)

(73) Assignee: Sony Corporation, Tokyo (JP)

(21) Appl. No.: 16/781,492

(22) Filed: Feb. 4, 2020

(51) Int. Cl. H04N 5/44; H04N 13/282; G06F 3/0487

(52) U.S. Cl. CPC H04N 5/4403; H04N 13/282; H04N 2005/4444; H04N 2005/4412; G06F 3/0487

(57) ABSTRACT

Implementations generally relate to providing a multiview experience. In some implementations, a method includes providing one or more multiview templates to a user in response to a multiview request. The method further includes determining a selected multiview template from the one or more multiview templates. The method further includes obtaining a plurality of media content items to be viewed by the user based on the selected multiview template. The method further includes populating the selected multiview template with the plurality of media content items. The method further includes enabling the user to view the plurality of media content items based on the selected multiview template.

### BACKGROUND

Televisions generally have multiview capability, where a user can simultaneously view more than one channel. Current multiview options in the US market are either controlled by a service provider as single blended channels or require the user to manually setup multiview each time the user desires to watch in multiview. A multiview option provided by a service provider might not suit the needs of the user. Setting up multiview manually each time can be tedious for the user. Furthermore, each service provider with a multiview option has different set up procedures, which may be difficult for a user to figure out.

### SUMMARY

Implementations generally relate to providing a multiview experience. In some implementations, a system includes one or more processors, and includes logic encoded in one or more non-transitory computer-readable storage media for execution by the one or more processors. When executed, the logic is operable to cause the one or more processors to perform operations including: providing one or more multiview templates to a user in response to a multiview request; determining a selected multiview template from the one or more multiview templates; obtaining a plurality of media content items to be viewed by the user based on the selected multiview template; populating the selected multiview template with the plurality of media content items; and enabling the user to view the plurality of media content items based on the selected multiview template.

With further regard to the system, in some implementations, the logic when executed is further operable to cause the one or more processors to perform operations including providing a multiview button, where user selection of the multiview button initiates a multiview experience. In some implementations, the logic when executed is further operable to cause the one or more processors to perform operations including providing a multiview button, where user selection of the multiview button initiates code that manages a multiview experience. In some implementations, at least one of the one or more multiview templates is curated. In some implementations, at least one of the one or more multiview templates is customized. In some implementations, a multiview experience includes one or more of video content and audio content. In some implementations, the populating of the selected multiview template with media content is based at least on context associated with the user.

In some embodiments, a non-transitory computer-readable storage medium with program instructions thereon is provided. When executed by one or more processors, the instructions are operable to cause the one or more processors to perform operations including: providing one or more multiview templates to a user in response to a multiview request; determining a selected multiview template from the one or more multiview templates; obtaining a plurality of media content items to be viewed by the user based on the selected multiview template; populating the selected multiview template with the plurality of media content items; and enabling the user to view the plurality of media content items based on the selected multiview template.

With further regard to the computer-readable storage medium, in some implementations, the instructions when executed are further operable to cause the one or more processors to perform operations including providing a multiview button, where user selection of the multiview button initiates a multiview experience. In some implementations, the instructions when executed are further operable to cause the one or more processors to perform operations including providing a multiview button, where user selection of the multiview button initiates code that manages a multiview experience. In some implementations, at least one of the one or more multiview templates is curated. In some implementations, at least one of the one or more multiview templates is customized. In some implementations, a multiview experience includes one or more of video content and audio content. In some implementations, the populating of the selected multiview template with media content is based at least on context associated with the user.

In some implementations, a method includes: providing one or more multiview templates to a user in response to a multiview request; determining a selected multiview template from the one or more multiview templates; obtaining a plurality of media content items to be viewed by the user based on the selected multiview template; populating the selected multiview template with the plurality of media content items; and enabling the user to view the plurality of media content items based on the selected multiview template.

With further regard to the method, in some implementations, the method further includes providing a multiview button, where user selection of the multiview button initiates a multiview experience. In some implementations, the method further includes providing a multiview button, where user selection of the multiview button initiates code that manages a multiview experience. In some implementations, at least one of the one or more multiview templates is curated. In some implementations, at least one of the one or more multiview templates is customized. In some implementations, a multiview experience includes one or more of video content and audio content.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for some implementations described herein.

FIG. 2 illustrates a block diagram of an example media environment, which may be used for some implementations described herein.

FIG. 3 is an example view of an example remote control device, according to some implementations.

FIG. 4 is an example flow diagram for providing a multiview experience, according to some implementations.

FIG. 5 illustrates a configuration of a multiview template with a tuned primary channel from a broadcaster, according to some implementations.

FIG. 6 illustrates a configuration of a multiview template with curated Internet protocol (IP) streams from a broadcaster, according to some implementations.

FIG. 7 illustrates a configuration of a multiview template that is a programmable interactive TV template, according to some implementations.

FIG. 8 illustrates a configuration of another multiview template that is a programmable interactive TV template, according to some implementations.

FIG. 9 illustrates a configuration of a multiview template that is a programmable live TV template, according to some implementations.

FIG. 10 illustrates a configuration of another multiview template that is a programmable live TV template, according to some implementations.

FIG. 11 illustrates example multiview templates showing different configurations, according to some implementations.

FIG. 12 illustrates a block diagram of an example network environment, which may be used for some implementations described herein.

FIG. 13 illustrates a block diagram of an example computer system, which may be used for some implementations described herein.

### DETAILED DESCRIPTION

Implementations described herein enable, facilitate, and manage multiview experiences for a user watching television. As described in more detail herein, embodiments provide convenient usage and customization of individually programmable multiview templates. These multiview templates enable a user to simultaneously view multiple channels on a television or other media devices.

In various embodiments, a system enables a user to initiate a multiview experience by simply selecting a single-access multiview button on a user device such as a smart phone, remote control device, etc. Selection of the multiview button triggers access to and/or set up of multiview templates that enable the user to enjoy a multiview experience. Various example embodiments directed to the multiview button and multiview templates are described in more detail herein.

In various embodiments, a system provides one or more programmable multiview templates to the user in response to a multiview request. The multiview request may be a press of a multiview button on a user device (e.g., smart phone, remote control device, etc.). The user may select from a combination of service provider-generated multiview templates and user-generated multiview templates. The system determines a user-selected multiview template from the provided multiview templates. The system then obtains media content items to be viewed by the user based on the selected multiview template. In various embodiments, the multiview templates determine the source of the media content. For example, a given multiview template may be used to present content-provider-curated media content items, user-selected media content items, or a combination thereof. The system then populates the selected multiview template with the media content items. The system then enables the user to view the media content items based on the selected multiview template. Various example embodiments directed to the multiview templates and configuration of the multiview templates are described in more detail herein.

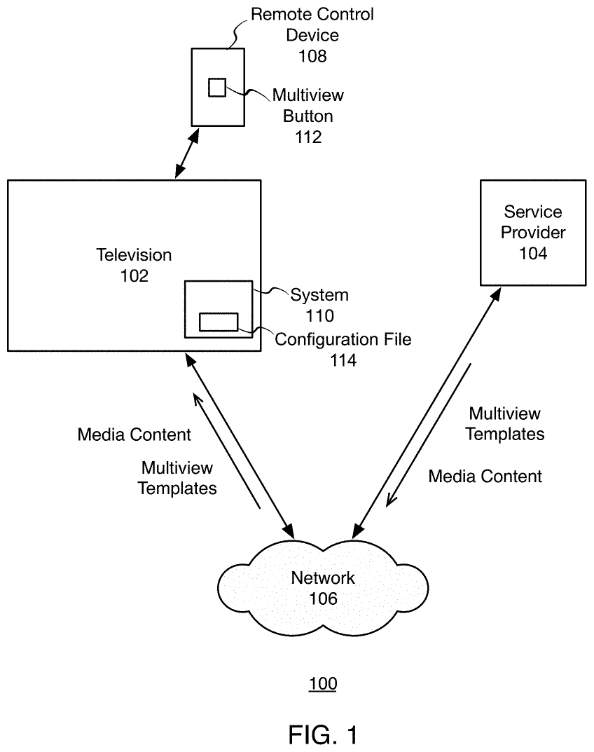

FIG. 1 illustrates a block diagram of an example media environment 100, which may be used for some implementations described herein. In some implementations, media environment 100 includes a television 102 and a service provider 104, which may communicate with each other via a network 106. The terms service provider and content provider may be used interchangeably. In some implementations, the network may be the Internet. In some implementations, the network may include a combination of networks such as the Internet, a wide area network (WAN), a local area network (LAN), a Wi-Fi network, a Bluetooth network, near-field communication (NFC) network, cable network, etc.

In various implementations, a user may use a remote control device 108 to communicate with a system 110 associated with television 102. The terms remote control device, remote control, and remote may be used interchangeably. Remote control device 108 includes various control buttons such as multiview button 112. For ease of illustration, one multiview button 112 is shown. There may be any number of other control buttons on remote control device 108. In various implementations, system 110 may be integrated with television 102, and may control television 102. In some alternative implementations, system 110 may also be separate from television 102, e.g., in a set-top box, and still control what gets displayed on the television 102.

In various embodiments, the system provides a multiview button such as multiview button 112, where user selection of multiview button 112 initiates the multiview experience. In various implementations, multiview button 112 is a single-access button that enables a user to initiate a process where the user may select a multiview template for simultaneously presenting various television channels on television 102. The terms multiview template and template may be used interchangeably. Multiview button 112 may be a physical button or a virtual button.

In various embodiments, the system provides multiview button 112, where user selection of the multiview button initiates code that manages the multiview experience. As such, multiview button 112 is a multifunction button. In various embodiments, multiview button 112 when selected initiates Java™ code and/or HTMLS JavaScript™ guides the user in programming or customizing a given multiview template. The code also enables multiview button 112 to be integrated with various services and television clients (e.g., ad insertion programs, program using APIs, etc.).

In various embodiments, the system overlays multiview templates in a viewing area on the television screen. This viewing area may be referred to as a viewing canvas, which includes one or more multiview templates. As described in more detail herein, in various embodiments, the system may configure each template with positioning or placement information that indicates where on the viewing canvas one or more multiview templates are positioned. The system also configures each multiview template with the particular media content and/or type of media content that are assigned to the multiview template. The type of media content may be a category such as sports, news, television shows, movies, etc. In various embodiments, the configuration information for a given multiview template enables layout graphics (e.g., HTMLS layout graphics, etc.) using cascading style sheets (CSS). The configuration information may also reference multiview templates as URLs transmitted over hypertext transfer protocol (HTTP).

As described in more detail herein, a service provider may provide one or more multiview templates to the system, which the system in turn presents the user. The user may select from a combination of service provider-generated multiview templates and user-generated multiview templates. Various example implementations directed to multiview tiles are described in detail herein.

In various implementations, multiview button 112 is associated with a configuration file 114 that is accessible by system 110. In this particular example implementation, configuration file 114 is stored at system 110. In some embodiments, configuration file 114 may be stored remotely from system 110 and may be accessible by system 110.

In various implementations, metadata associated with the tiles and presentation policies may be stored in configuration file 114 that is accessible by system 110. In this particular example implementation, configuration file 114 is stored at system 110. In some embodiments, the configuration file may be stored remotely from system 110 and may be accessible by system 110.

In various embodiments, television offerings may be provided by a service provider such as service provider 104, for example. System 110 may communicate with service provider 104 on behalf of television 102 in order to access such television offerings upon selection by a user. Various example implementations directed to the presentation of television offerings are described in detail herein.

Although implementations disclosed herein are described in the context of televisions, the implementations may also apply to other media player devices such as Blu-ray™ players, computers, tablets, smart phones etc. In various embodiments, the multiview template may also have some non-TV elements (e.g., video games, applications, etc.).

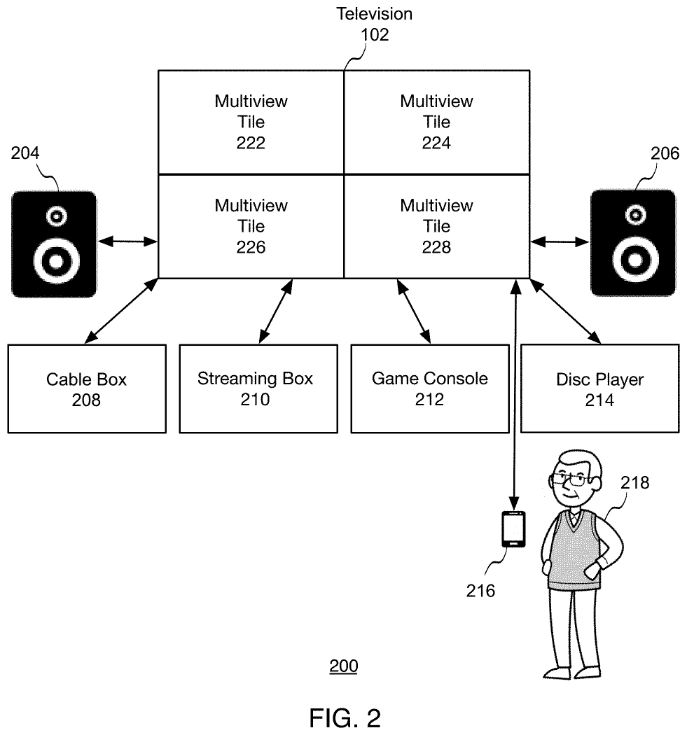

FIG. 2 illustrates a block diagram of an example media environment 200, which may be used for some implementations described herein. In some implementations, media environment 200 includes television 102, speakers 204 and 206, a cable box 208, a streaming box 210, a game console 212, a disc player 214, and a remote control device 216. Also shown is a user 218.

Also shown are multiview tiles 222, 224, 226, and 228, which are displayed on television 102 based on a multiview template. As indicated herein, the multiview tiles display different channels, thereby enabling the user to view multiple channels simultaneously on the television screen. In various embodiments, multiview button 112 may used to turn on or off the multiview screen.

For ease of illustration, in the example embodiment shown, the template configures multiview tiles 222, 224, 226, and 228 in a quad configuration. The particular configuration may vary, depending on the particular template. As described in more detail herein, each multiview template is individually and independently programmable. This enables the user to customize the configuration of each multiview tile. As described in more detail herein, the configuration of a given multiview tile may include the configuration of the layout (e.g., how the multiview tiles are positioned on the screen, etc.) and configuration of the media content that is displayed (e.g., what content is fetched for display on a given multiview tile, etc.). The terms multiview tile, tile, sub-screen, sub-displays, sub-divisions, divisions and may be used interchangeably. Various example implementations directed to the multiview tiles described in detail herein.

In some implementations, regardless of what media content a user is watching, multiview button 112 may be viewed functionally like a video on demand (VOD) button, in that it immediately identifies where the user is in the television menu system and/or the input source. For example, input sources may include high-definition multimedia interface (HDMI), Internet protocol (IP), over-the-air programming (OTA), etc.

In various implementations, a system that is integrated into television 102 facilitates the user in configuring the settings of television 102. In various implementations, television 102 may communicate with user 218 via a remote control device such as remote control device 216. Remote control device 216 may be used to implement remote control device 108 of FIG. 1. In this particular example, remote control device 216 is a smart phone that has remote control functions. In various implementations, the remote control device may be any remote control device such as one provided by the manufacture of television 102. As described in more detail herein, television 102 may also communicate with the user 218 by voice.

While some implementations are described herein in the context of the system residing in television 102, these implementations also apply to the system residing in other devices or located in other locations (e.g., in the cloud).

In other implementations, media environment 100 may not have all of the components shown and/or may have other elements including other types of elements instead of, or in addition to, those shown herein. In the various implementations described herein, a processor of television 102 may cause the elements described herein (e.g., multiview templates, media content items, etc.) to be displayed in the user interface on one or more display screens.

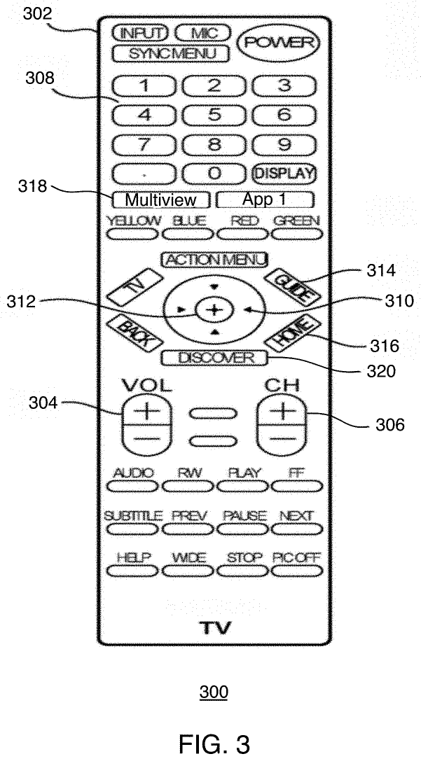

FIG. 3 is an example view of an example remote control device 300, according to some implementations. Remote control device 300 may be used to implement remote control device 108 of FIG. 1. In various implementations, remote control device 300 may include one or more internal processors, computer memories, and wireless transmitters such as infrared (IR) command transmitters to control a device such as television 102 of FIG. 1.

As shown, remote control device 300 includes a typically plastic, hand-holdable housing 302 with multiple input keys that can be manipulated by a person to cause wireless commands to be sent from the remote control device 300 to television 102 (e.g., to system 110). Volume up and down keys 304 may be manipulated to respectively turn the volume of the speakers of television 102 up and down. Channel up and down keys 306 may be manipulated to respectively change the channels of television 102 up and down. An alpha-numeric keypad 308 may be provided on remote control device 300 for inputting letters and/or numbers to television 102. Also, a directional input element such as a rocker 310 or directional keys may be provided with each arm of the rocker being manipulable to move a screen cursor up and down and left and right. If desired, a select key 312 may be located in the center of the rocker 310 for input of a “select” command.

Further, in the example shown, remote control device 300 may include a guide key 314 manipulable to send a command to present an electronic program guide (EPG) on television 102. Also, a home key 316 may be provided and can be manipulated to invoke a home menu. A special accessibility key may be provided. As shown, many other keys also may be provided, making the task for a blind person to learn the functions of the keys daunting.

Also shown is a multiview button 318. In various embodiments, multiview button 318 may be used to implement button 112 of FIG. 1. Multiview button 318 may be a physical button or a virtual button. In various implementations, multiview button 318 enables a user to initiate a process where the user may select a multiview template for simultaneously presenting various television channels on television 102. As described in more detail herein, each multiview template includes a configuration of programmable sub-screens or tiles, each of which displays a different television channel. Various example implementations directed to the tiles are described in detail herein.

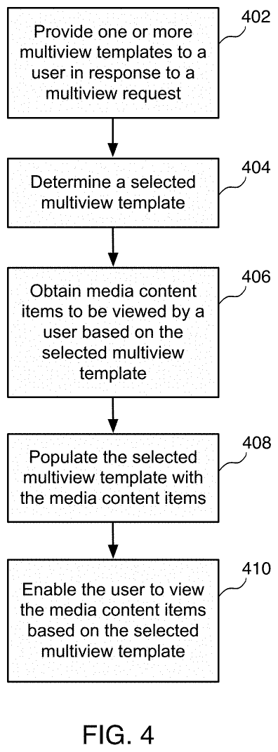

FIG. 4 is an example flow diagram for providing a multiview experience, according to some implementations. Referring to both FIGS. 1 and 4, a method is initiated at block 402, where a system such as system 110 provides one or more multiview templates to a user in response to a multiview request. In various embodiments, the multiview request is sent from a remote control device to the system when the user selects multiview button 112 on remote control device 108. In response to receipt of the multiview request, the system presents or displays one or more multiview templates on the screen of television 102. In various embodiments, one or more multiview templates may be curated. Such curated multiview templates may be provided by any number of service providers. As described in more detailed herein, such curated multiview templates are preconfigured by the providing service provider. In various embodiments, one or more multiview templates may be customized. As described in more detail herein, such customized multiview templates may be existing templates that the user has used before and that the user modifies. Such customized multiview templates may also be new templates that the user customizes to suit his or her needs.

Example embodiments directed to curated multiview templates and customized multiview templates are described in more detail herein. In various embodiments, the system enables multiview templates to be copied, stored, and reused. These multiview templates may be listed in a multiview template directory, which may be stored locally or in the cloud.

In various embodiments, the multiview experience may include video content, audio content, and/or a combination thereof. For example, some multiview tiles may present both video and audio (e.g., movies, television shows, etc.) to the user. Some multiview tiles may present audio (e.g., music, news, etc.) to the user. Some multiview tiles may present video without audio (e.g., video of a baby in another room, children playing outside, etc.) to the user. In some embodiments, some multiview tiles may present images (e.g., photos, graphic artwork, etc.) to the user.

Referring still to FIG. 4, at block 404, the system determines a selected multiview template from the one or more multiview templates. In various embodiments, the system enables the user to scroll through various different multiview templates and then select one for a multiview experience. The system enables the user to select the desired multiview tile.

At block 406, the system obtains media content items to be viewed by the user based on the selected multiview template. In various embodiments, the configuration of a given multiview template configures the positioning or layout of the multiview template (e.g., side-by-side configuration, quad configuration, etc.). In various embodiments, the configuration of a given multiview template also configures the content that is procured and displayed in the multiview tile.

In some embodiments, the system may present or display one or more multiview templates based on the context currently active in the television. For example, if the user is viewing a sports event, the system may present one or more preconfigured multiview templates suited for sports events. For example, a given multiview template may be configured to display media content in the same category that the user is currently viewing, such as a main sports event (e.g., football game, etc.). The multiview template may also have smaller multiview tiles in which the system displays other sports events (e.g., other football games that the user may want to track), sports statistics, etc. As described in more detail herein, the system may also enable the user to program or customize a given multiview template to display particular media content items, which may be stored locally by the system and/or in the television and/or may be stored remotely in the cloud.

In various embodiments, if the system facilitates the user in customizing a given multiview template, the system enables the user to use the remote navigation keys to highlight the appropriate viewing tile. The user may then assign one or more content media items, categories of content media items, and/or media content source to the multiview template. For example, the system may enable the user to select the content source type (e.g., OTA broadcast, cable, streaming applications, attached devices, etc.), which ultimately results in the display of saved or live media content.

In some embodiments, the system may obtain one or more media content items based on the viewing history of the user. For example, if the user has historically watched particular content such as sports, news, etc. from particular service providers, the system may procure media content items from those sources. In some embodiments, the system may also obtain one or more media content items that the user has previously viewed from a multiview library located on the television. In some embodiments, the system may also obtain one or more media content items based on applying metadata tags from an IP library of multiview, curated media content.

In some embodiments, the system may evaluate the current input context, including the source of the media content (e.g., live TV, VOD, OTA, DVR, channel guide, an application, etc.). The system may then select the framework or multiview template based on the source. The system may then select the content to fill the multiview template. In some embodiments, the system may apply one or more audio preferences (e.g., on-field audio, etc.). The system may also make appropriate fine-tuning adjustments to the viewing canvas (the displayed multiview tiles). In various embodiments, the system enables the user to save and store any given template for future, instant retrieval. In some embodiments, the system may enable the user to share his or her templates with other users (e.g., friends, family, etc.).

At block 408, the system populates the selected multiview template with the media content items. As indicated above, the system populates the selected multiview template based on its configuration. In various embodiments, this may include the system populating the selected multiview template with media content based at least on context associated with the user.

At block 410, the system enables the user to view the media content items based on the selected multiview template. As a result, the user enjoys a customized multiview experiences tailored to the preferences of the user. Further embodiments directed to multiview tiles are described in detail herein.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In various embodiments, the system provides a multiview button, where user selection of the multiview button initiates code that manages the multiview experience. In various embodiments, the code may include Java™ code and JavaScript™. The particular types of code used may vary, depending on the particular implementation.

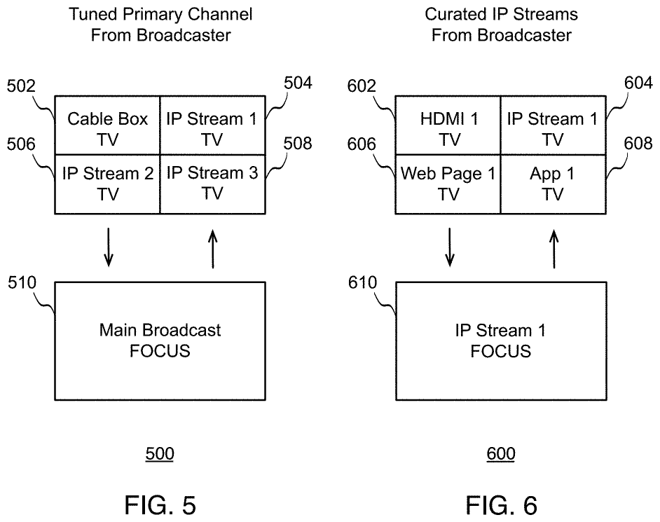

FIG. 5 illustrates a configuration 500 of a multiview template with a tuned primary channel (“Main Broadcast”) from a broadcaster, according to some implementations. Shown are multiview tiles 502, 504, 506, and 508. In this example embodiment, the four-tiled canvas has four individual fields of video or display that are independent of each other. They are independent of each other in that the system enables them to be separately controlled. In some embodiments, the system may group and related the tiles to each other by theme (e.g., relating to the same event such a sports event, etc.). In various embodiments, the system may associate each tile with the same event ID. This means the videos are being delivered in a group of videos curated by the broadcaster. In some embodiments, different tiles may provide separate camera angles or individual sources of content of the same event. In some embodiments, different tiles may focus on particular parts of the event, such as men's track and field events. In some embodiments, each title may display a separate sub-event.

Also, shown is box 510, which represents a tuned primary channel from a broadcaster. In various embodiments, the system enables the user to select a tile from within the multiview template (e.g., from tiles 502, 504, 506, and 508) that has dominant audio and where the JavaScript execution is currently being derived for primary playback. In some embodiments, this means is that interactive elements are directed at that screen or from that screen unless otherwise overridden by the template. A primary view is the one currently dominant and being used as the main viewing screen. It does not have to be a larger size. In this particular embodiment, box 510 (labeled “Main Broadcast”) may represent content from tile 502, for example. The label “FOCUS” may indicate the selection of a tile, which because the focus.

In some embodiments, the system may enable a user to select multiview templates provided by a service provider. Such multiview templates may have pre-built formats or configurations (e.g., picture in picture, side-by-side pictures, quad views, etc.). For example, screen tiles 502, 504, 506, and 508 are arranged in a quad configuration.

In various embodiments, the multiview template may include a curated mix of content that the service provider provides. In this particular example embodiments, screen tile 502 displays media content from a cable box source. Also, screen tile 504 displays media content from IP Stream 1, screen tile 506 displays media content from IP Stream 2, and screen tile 508 displays media content from IP Stream 4.

FIG. 6 illustrates a configuration 600 of a multiview template with curated IP streams from a broadcaster, according to some implementations. Shown are screen tiles 602, 604, 606, and 608. Also, shown is box 610, which represents the IP Stream 1 channel from the broadcaster.

In various embodiments, the multiview template may include a curated mix of content that the service provider provides. As shown, screen tile 602 displays media content from HDMI 1. Also, screen tile 604 displays media content from IP Stream 1. Screen tile 606 displays media content from Web Page 1. Screen tile 608 displays media content from Application (App) 1.

While the service provider provides the multiview template as well as the curated content, in various embodiments, the system enables the user to modify the multiview template and/or the content shown in the tiles. Further example embodiments directed to the modification of multiview templates, as well as the creation of new multiview templates, are described in more detail herein.

In various embodiments, the multiview templates enable particular shows or types of shows to be watched together, simultaneously, as opposed the user needing to flip back and forth between shows. These shows may be from a group of favorite shows designated by the user or based on the user's viewing history. These shows may also be from a system-suggested or pre-mix of shows. The following are further example embodiments directed to the customization of multiview templates.

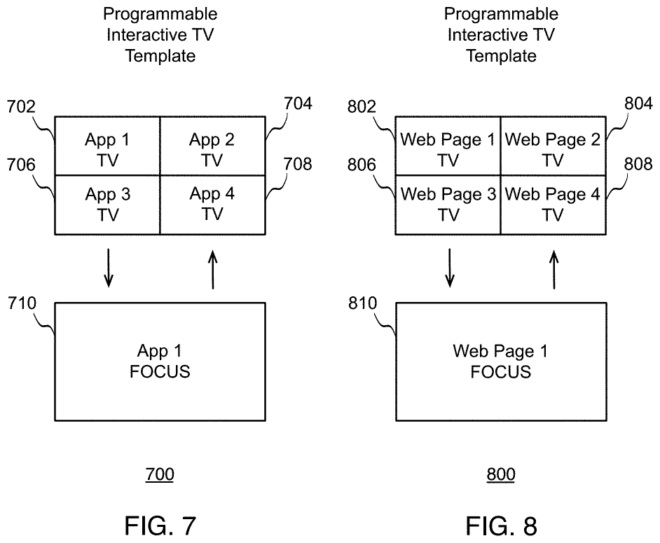

FIG. 7 illustrates a configuration 700 of a multiview template that is a programmable interactive TV template, according to some implementations. Shown are screen tiles 702, 704, 706, and 708. Also, shown is box 710, which represents App 1.

As shown, screen tile 702 displays App 1. Screen tile 704 displays App 2. Screen tile 706 displays App 3. Screen tile 708 displays App 4.

FIG. 8 illustrates a configuration 800 of another multiview template that is a programmable interactive TV template, according to some implementations. Shown are screen tiles 802, 804, 806, and 808. Also, shown is box 810, which represents Web Page 1.

As shown, screen tile 802 displays Web Page 1. Screen tile 804 displays Web Page 2. Screen tile 806 displays Web Page 3. Screen tile 808 displays Web Page 4.

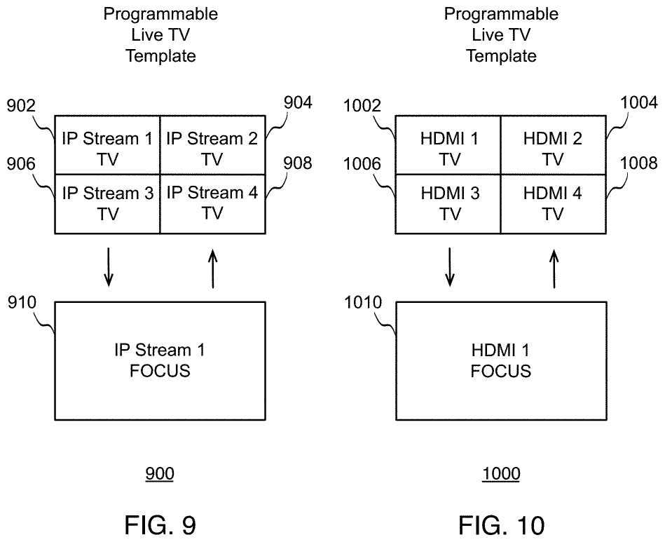

FIG. 9 illustrates a configuration 900 of a multiview template that is a programmable live TV template, according to some implementations. Shown are screen tiles 902, 904, 906, and 908. Also, shown is box 910, which represents IP Stream 1.

As shown, screen tile 902 displays IP Stream 1. Screen tile 904 displays IP Stream 2. Screen tile 906 displays IP Stream 3. Screen tile 908 displays IP Stream 4.

FIG. 10 illustrates a configuration 1000 of another multiview template that is a programmable live TV template, according to some implementations. Shown are screen tiles 1002, 1004, 1006, and 1008. Also, shown is box 1010, which represents HDMI 1.

As shown, screen tile 1002 displays HDMI 1. Screen tile 1004 displays HDMI 2. Screen tile 1006 displays HDMI 3. Screen tile 1008 displays HDMI 4.

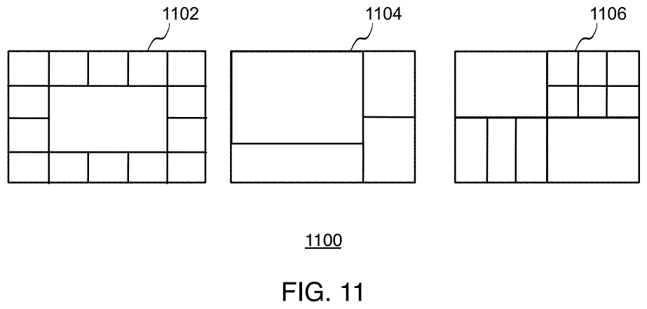

FIG. 11 illustrates example multiview templates 1102, 1104, and 1106 showing different configurations, according to some implementations. In various embodiments, the system enables the user to create different sized windows for each multiview tile. For example, the user may designate a given multiview tile as a main viewing tile and scale that multiview tile to be bigger than other multiview tiles. The user may configure the size and shape of each multiview template, the layout of the multiview templates on the viewing canvas, the type of each media content in each of the multiview templates, as well as other details associated with each multiview template (e.g., URL, channel, etc.).

Multiview template 1102 shows a configuration, where a large tile is positioned in the center with smaller tiles positioned around the large tile. Multiview template 1104 shows a configuration, where a large tile is positioned in the upper right with smaller tiles positioned the right of and below the large tile. Multiview template 1106 shows a configuration, where two relatively larger tiles are positioned in the upper left and the lower right, and smaller tiles are positioned in the lower left and upper right. As such, the user may have various types of configurations (e.g., layouts, associated media contents, etc.) assigned to each multiview template.

In some scenarios, a multiview template may provide a news view. In some scenarios, a multiview template may provide a movie view. In some scenarios, a multiview template may provide an electronic program guide (EPG) view. By creating customizable views, the system enables the user to organize his or her media content in very useful ways, creating multiview experiences desired by the user.

In various embodiments, different users (e.g., friends, family members, etc.) may be associated with different multiview templates. Furthermore, different multiview templates associated with different users may be displayed on the same viewing canvas. As such, different users may watch different respective multiview templates on the same viewing canvas or television screen.

In some embodiments, the system may automatically adjust any one or more multiview tiles to fit the physical screen size of the television. In some embodiments, the system may suggest numbers and sizes of one or more multiview tiles based on the physical screen size of the television and/or based on available free space on the viewing canvas.

Implementations described herein provide various benefits. For example, implementations enable a user to enjoy a multiview experience in a manner that is customized to the user. Implementations described herein also enable the user to use existing multiview templates provided by a service provider, and/or existing multiview templates created by or modified by the user, and/or newly created multiview templates created by the user. Embodiments enable each member of a household to personalize their own multiview experience. □ Embodiments enable a user to have multiple multiview experiences depending on the situation (e.g., sports view, information view, news view, music view, etc.). Embodiments provide user with quick and easy access to media content that interests the user. □

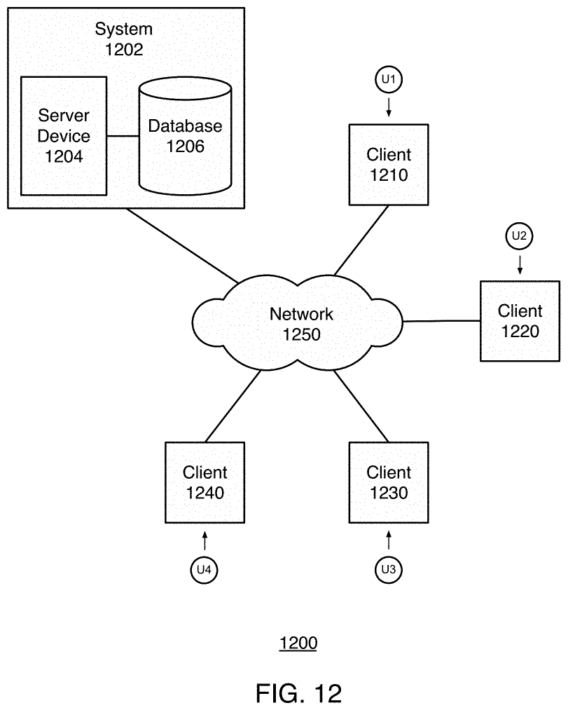

FIG. 12 illustrates a block diagram of an example network environment 1200, which may be used for implementations described herein. In some implementations, network environment 1200 includes a system 1202, which includes a server device 1204 and a database 1206. Network environment 1200 also includes client devices 1210, 1220, 1230, and 1240, which may communicate with system 1202 and/or may communicate with each other directly or via system 1202. Network environment 1200 also includes a network 1250 through which system 1202 and client devices 1210, 1220, 1230, and 1240 communicate. Network 1250 may be any suitable communication network such as a Wi-Fi network, Bluetooth network, the Internet, etc.

For ease of illustration, FIG. 12 shows one block for each of system 1202, server device 1204, and network database 1206, and shows four blocks for client devices 1210, 1220, 1230, and 1240. Blocks 1202, 1204, and 1206 may represent multiple systems, server devices, and databases. Also, there may be any number of client devices. In other implementations, network environment 1200 may not have all of the components shown and/or may have other elements including other types of elements instead of, or in addition to, those shown herein.

While server 1204 of system 1202 performs embodiments described herein, in other embodiments, any suitable component or combination of components associated with server 1202 or any suitable processor or processors associated with server 1202 may facilitate performing the embodiments described herein.

System 1202 and/or any of client devices 1210, 1220, 1230, and 1240 may perform implementations described herein individually or in combination with other devices. In the various implementations described herein, a processor of system 1202 and/or a processor of any client device 1210, 1220, 1230, and 1240 causes the elements described herein (e.g., templates, etc.) to be displayed in a user interface on one or more display screens.

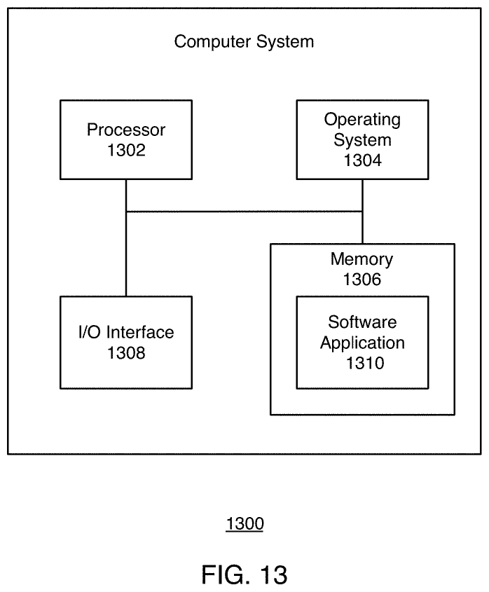

FIG. 13 illustrates a block diagram of an example computer system 1300, which may be used for some implementations described herein. For example, computer system 1300 may be used to implement system 110 of FIG. 1, as well as to perform implementations described herein. In some implementations, computer system 1300 may include a processor 1302, an operating system 1304, a memory 1306, and an input/output (I/O) interface 1308. In various implementations, processor 1302 may be used to implement various functions and features described herein, as well as to perform the method implementations described herein. While processor 1302 is described as performing implementations described herein, any suitable component or combination of components of computer system 1300 or any suitable processor or processors associated with computer system 1300 or any suitable system may perform the steps described. Implementations described herein may be carried out on a user device, on a server, or a combination of both.

Computer system 1300 also includes a software application 1310, which may be stored on memory 1306 or on any other suitable storage location or computer-readable medium. Software application 1310 provides instructions that enable processor 1302 to perform the implementations described herein and other functions. Software application may also include an engine such as a network engine for performing various functions associated with one or more networks and network communications. The components of computer system 1300 may be implemented by one or more processors or any combination of hardware devices, as well as any combination of hardware, software, firmware, etc.

For ease of illustration, FIG. 13 shows one block for each of processor 1302, operating system 1304, memory 1306, I/O interface 1308, and software application 1310. These blocks 1302, 1304, 1306, 1308, and 1310 may represent multiple processors, operating systems, memories, I/O interfaces, and software applications. In various implementations, computer system 1300 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The terms embodiments and implementations are used interchangeably.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
providing a multiview button, wherein user selection of the multiview button initiates a multiview experience where one or more multiview templates are provided on a screen of television;
providing the one or more multiview templates to a user in response to a multiview request;
determining a selected multiview template from the one or more multiview templates;
obtaining a plurality of media content items to be viewed by the user based on the selected multiview template;
populating the selected multiview template with the plurality of media content items; and
enabling the user to view the plurality of media content items based on the selected multiview template.

2. The system of claim 1, wherein the multiview request is a press of the multiview button.

3. The system of claim 1, wherein user selection of the multiview button initiates code that manages a multiview experience.

4. The system of claim 1, wherein at least one of the one or more multiview templates is curated.

5. The system of claim 1, wherein at least one of the one or more multiview templates is customized.

6. The system of claim 1, wherein a multiview experience comprises one or more of video content and audio content.

7. The system of claim 1, wherein the populating of the selected multiview template with media content is based at least on context associated with the user.

8. A non-transitory computer-readable storage medium with program instructions stored thereon, the program instructions when executed by one or more processors are operable to cause the one or more processors to perform operations comprising:
providing a multiview button, wherein user selection of the multiview button initiates a multiview experience where one or more multiview templates are provided on a screen of television;
providing the one or more multiview templates to a user in response to a multiview request;
determining a selected multiview template from the one or more multiview templates;
obtaining a plurality of media content items to be viewed by the user based on the selected multiview template;
populating the selected multiview template with the plurality of media content items; and
enabling the user to view the plurality of media content items based on the selected multiview template.

9. The computer-readable storage medium of claim 8, wherein the multiview request is a press of the multiview button.

10. The computer-readable storage medium of claim 8, wherein user selection of the multiview button initiates code that manages a multiview experience.

11. The computer-readable storage medium of claim 8, wherein at least one of the one or more multiview templates is curated.

12. The computer-readable storage medium of claim 8, wherein at least one of the one or more multiview templates is customized.

13. The computer-readable storage medium of claim 8, wherein a multiview experience comprises one or more of video content and audio content.

14. The computer-readable storage medium of claim 8, wherein the populating of the selected multiview template with media content is based at least on context associated with the user.

15. A computer-implemented method comprising:
providing a multiview button, wherein user selection of the multiview button initiates a multiview experience where one or more multiview templates are provided on a screen of television;
providing the one or more multiview templates to a user in response to a multiview request;
determining a selected multiview template from the one or more multiview templates;
obtaining a plurality of media content items to be viewed by the user based on the selected multiview template;
populating the selected multiview template with the plurality of media content items; and
enabling the user to view the plurality of media content items based on the selected multiview template.

16. The method of claim 15, wherein the multiview request is a press of the multiview button.

17. The method of claim 15, wherein user selection of the multiview button initiates code that manages a multiview experience.

18. The method of claim 15, wherein at least one of the one or more multiview templates is curated.

19. The method of claim 15, wherein at least one of the one or more multiview templates is customized.

20. The method of claim 15, wherein a multiview experience comprises one or more of video content and audio content.
